(19) United States
(12) Patent Application Publication
(10) Pub. No.: US 2016/0287037 A1
(43) Pub. Date: Oct. 6, 2016

(54) Flexible Converting Cover for Combination Potty and Child Car Seat

(71) Applicant: Edward W. Carroll, South Plainfield, NJ (US)

(72) Inventor: Edward W. Carroll, South Plainfield, NJ (US)

(21) Appl. No.: 14/679,215

(22) Filed: Apr. 6, 2015

(51) Int. Cl. A47K 11/04; B60N 3/08; B60N 2/26

(52) U.S. Cl. CPC A47K 11/04; B60N 2/26; B60N 3/08

(57) ABSTRACT

The present invention relates to a combination potty and child's car seat that comprises a flexible converting cover that a) in a first position converts the combination potty and child's car seat to a potty and b) in a second position converts the combination potty and child's car seat to a child's car seat.

### FIELD OF INVENTION

The present invention is directed to child safety seats for automobiles, and is particularly directed to child safety seats for automobiles that include a potty feature. More particularly, the present invention is directed to an automobile child safety seat that includes a flexible cover that, when covering the potty discharge opening, converts the seat into a child safety seat; and, when uncovering the potty discharge opening, converts the seat into a potty. Further, the present invention is directed to the flexible converting cover comprising a pocket that contains a sheet of firm material sufficient to support a child when the sheet is positioned cooperatively with the discharge opening.

### BACKGROUND OF THE INVENTION

U.S. Pat. No. 2,994,557 describes a child's convertible chair. U.S. Pat. No. 3,127,215 describes an infant seat and bed. U.S. Pat. No. 4,199,826 describes a portable toilet. U.S. Pat. No. 4,798,412 describes a booster seat. U.S. Pat. No. 4,854,638 describes an adjustable child seat. U.S. Pat. No. 5,685,029 describes a toilet. U.S. Pat. No. 5,775,771 describes a car seat. U.S. Pat. No. 5,778,460 describes an auxiliary toilet seat. U.S. Pat. No. 5,978,976 describes a potty. U.S. Pat. No. 6,227,931 describes an electronic play set.

U.S. Pat. No. 6,240,576 describes a portable toilet. U.S. Pat. No. 6,341,386 describes a portable potty. U.S. Pat. No. 6,634,712 describes a child stool. U.S. Pat. No. 7,321,315 describes a disposable absorbent. U.S. Pat. No. 7,313,833 describes a vehicle emergency toilet system. U.S. Pat. No. 7,537,284 describes a car seat cover. U.S. Pat. No. 7,665,157 describes a toilet training chair.

U.S. Pat. No. 7,712,159 describes a convertible potty chair. Chinese Patent Publication CN2259814Y describes multi-function sets of furniture for children's daily use including a sliding bedpan. Chinese Patent Publication CN201418585Y describes multi-function children seat with a fecal discharge container that slides out from under the seat.

US Pat. No. D351,224 describes a toilet trainer. US Pat. No. D621,486 describes an animal character potty chair. US Pat. No. D637,272 describes combination portable toilet and baby changing table. US Pat. No. D639,403 describes a potty.

US Pat. No. D652,640 describes a combination car potty seat.

When travelling with a young child in an automotive vehicle such as a car, sport utility vehicle, or minivan, the child must be safely confined in a child car seat. Vehicular trips are interrupted when children need to use the toilet. The vehicle needs to stop at an appropriate location to use a public permanent toilet or to set up and use a portable toilet. There are many situations when such interruptions are undesirable or difficult such as in unfamiliar areas, in dangerous areas, or in very heavy traffic areas. Thus, there is a need for convenient in-vehicle toilets.

Young children are often not able to give adequate warning of their need to use a toilet with sufficient time to find a public toilet facility. Especially in an unfamiliar area, the adult may not know, or be able to find, a convenient public toilet nearby. Further, the child might not have the ability to hold in the toilet need long enough to wait for the public toilet. A consequence is that the vehicle seat be become soiled. Thus, there is a need for a potty in the vehicle conveying a child. A convenient place for a potty is the child seat itself because children generally must be confined in such child seats when being driven in a vehicle. Accordingly, there is a need for child seats that convert easily into a potty.

Child seats are often taken in and out of vehicles for various reasons. For example, they may serve as convenient seats in the house or new destinations. Children may be familiar with the car seat and thus gain comfort in sitting in a familiar chair when in unfamiliar surroundings. Parents and caretakers move a considerable amount of items while moving a child from place to place. Such items can include, for example, diapers, formula, toys, clothes, and cleaning wipes, along with the car seat and the child. Thus, added convenience and weight savings are important factors in child accessories.

### SUMMARY OF THE INVENTION

The present invention concerns a child's car seat that conveniently converts to a potty. In one aspect the present invention is a combination potty and child's car seat comprised of a flexible converting cover that a) in a first position converts the combination potty and child's car seat to a potty and b) in a second position converts the combination potty and child's car seat to a child's car seat.

In an embodiment of the present invention, the flexible converting cover is made of woven fabric, soft polymer sheeting, multi-laminar polymer materials, closed or open pore foam sheets, woven, tufted, knotted, or other carpeting material, or terry cloth.

In another embodiment of the present invention, the flexible converting cover includes a recess that contains an inflexible sheet, wherein the inflexible sheet is located correspondingly to a potty waste discharge opening.

### DETAILED DESCRIPTION OF THE INVENTION

Combination child car seat/potty devices are commonly described with a converting cover that in one position converts the device to a child car seat by covering the waste discharge opening thereby allowing the child to sit on the seat, and in a second position converts the device to a potty by allowing the child access to the discharge opening thereby allowing the child to sit on the device and use it as a potty. An example of a converting cover is shown in US D652,640, in which a round lid is shown in its FIG. 1 in a position where the device is a child car seat, while in the patent's FIG. 2 the converting cover is shown in a position where the device is a potty.

The converting cover is commonly a substantially inflexible cover optionally having a cushioning layer on its seat top surface for the child's comfort while sitting on the device in use as a child car seat. However, the present invention replaces the thick heavy inflexible cover with a flexible cover made of any convenient soft flexible material such as, for example, woven fabric, soft polymer sheeting, multi-laminar polymer materials, closed or open pore foam sheets, woven, tufted, knotted, or other carpeting material, or terry cloth. The soft flexible material can be absorbent or waterproof. The material can also be absorbent on one front surface side while the back surface can be waterproof.

The present invention saves weight over the cushioned inflexible conversion cover. Weight saved is important to the parent struggling to remove or replace the child car seat while minding the child. The present invention is easier to keep clean as the entire cover can be removed and deposited into a washing machine to cleanse the entire cover. The conventional covers (often pivoting) can have recesses that are hard to reach with cleansers and, thus, can accumulate dirt over time. Further, the present invention is comfortable for the child, similar to sitting on a chair with cloth upholstery.

Furthermore, the present invention optionally includes a recess that contains an inflexible sheet that is situated correspondingly to the potty discharge opening. This inflexible sheet serves to bridge the discharge opening to that the soft flexible material of the cover of the present invention does not sag into the discharge opening. Accordingly, the optional inflexible sheet obviates the psychological awareness of the discharge opening that such sagging may induce.

The inflexible sheet can be made from any convenient material such as, for example, polymer sheeting, thin metal sheeting, stiff woven material, or pressed cellulosic material.

The inflexible sheet can be incorporated into a recess in the soft flexible cover that can be conveniently accessed to remove the inflexible sheet prior to washing the soft flexible cover. The recess can be a pocket in the soft flexible cover. The recess can conveniently have, for example, clasps, buttons, hook-and-loop closures, or zippers to hold the inflexible sheet in place.

The inflexible sheet can be held in place on the surface of the soft flexible cover (preferable on the surface towards the discharge opening) by convenient mountings, such as for example, clasps, snaps, or latches that allow the inflexible sheet's removal prior to washing the soft flexible cover.

A material is defined as a “flexible” or “inflexible” material, when in the form as used in the present invention, according to its performance in the following flexibility test: 1) place a 1 inch long steel cylinder, ¾ inch in diameter, on a level surface with the cylinder's axis orthogonal to the surface. 2) place a 6 inch diameter circular sheet of the test material on top of the cylinder with the center of the circular sheet at the axis of the cylinder. 3) the test material is flexible if the material touches the level surface; the test material is inflexible if the material does not touch the level surface.

It is understood that the invention is not limited to the presented details of the construction, materials, and embodiments. The above disclosure of specific embodiments is illustrative of the broad concepts embraced by the present invention.

What is claimed is:

1. A combination potty and child's car seat comprising:
a flexible converting cover that a) in a first position converts the combination potty and child's car seat to a potty and b) in a second position converts the combination potty and child's car seat to a child's car seat.

2. The combination potty and child's car seat according to claim 1, wherein the flexible converting cover is composed of woven fabric, soft polymer sheeting, multi-laminar polymer materials, closed or open pore foam sheets, woven, tufted, knotted, or other carpeting material, or terry cloth.

3. The combination potty and child's car seat according to claim 1, wherein the flexible converting cover includes a recess that contains an inflexible sheet, wherein the inflexible sheet is located correspondingly to a potty waste discharge opening.
